(19) United States
(12) Patent Application Publication
(10) Pub. No.: US 2026/0028187 A1
(43) Pub. Date: Jan. 29, 2026

(54) WAREHOUSING SYSTEMS, SCHEDULING METHOD, AND WORKSTATION

(71) Applicant: BEIJING GEEKPLUS TECHNOLOGY CO., LTD., Beijing (CN)

(72) Inventors: Xianli SHEN, Beijing (CN); Hao HAN, Beijing (CN); Wenzhe TAN, Beijing (CN); Chengye ZHAO, Beijing (CN); Xiguang WEI, Beijing (CN)

(21) Appl. No.: 18/996,651

(22) PCT Filed: Aug. 14, 2023
(86) PCT No.: PCT/CN2023/112805

§ 371 Date: Jan. 17, 2025

(30) Foreign Application Priority Data
Sep. 14, 2022 (CN) 202211116139.3

(51) Int. Cl. B65G 1/137; G06Q 10/087

(52) U.S. Cl. CPC B65G 1/1378; G06Q 10/08741

(57) ABSTRACT

A warehousing system includes a plurality of movable holders, a movable carrier park area, a control device, a workstation and handling equipment. The control device is configured to obtain an order, and determine a bound container and a bound holder according to the order. The bound holder is a movable holder carrying the bound container. The handling equipment is configured to transport all the bound holders parked in the movable holder parking area to the workstation, and at least two bound holders are transported to the same workstation. The workstation is configured to exchange a container on a first bound holder and a bound container on a second bound holder according to the cargo collection attribute of the bound container, to improve the consistency of cargo collection attribute of the container on the first bound holder.

### CROSS-REFERENCE TO RELATED APPLICATIONS

The present application is a national stage entry under 35 U.S.C. § 371 of International Application No. PCT/CN2023/112805 filed on Aug. 14, 2023, which claims priority to Chinese Patent Application No. 202211116139.3, filed on Sep. 14, 2022, the entire disclosures of which are hereby incorporated herein by reference.

### FIELD

The present disclosure relates to the technical field of warehousing equipment, and particularly to a warehousing system, a scheduling method, a workstation and a hub station.

### BACKGROUND

In logistics enterprises, the picking is completed according to an order, cargo boxes bound to the order (order boxes) are often scattered on each rack in different positions in the warehouse, and cargo collection work of cargo boxer needs to be completed manually, which leads to a large manual workload and increases the labor cost.

### SUMMARY

A first aspect of embodiments of the present disclosure provides a warehousing system including: a plurality of movable holders, a mobile holder parking area, a workstation, a handling equipment, and a control device. The movable holder includes a plurality of placement positions, and the placement position is used to place a container for storing cargo. The movable holder parking area includes a plurality of parking positions, and each parking position is used to park one movable holder. The control device is configured to obtain an order and determine the bound container and the bound holder according to the order. The bound holder is a movable holder carrying the bound container. The handling equipment is coupled to the control device and configured to transport all bound holders parked in the movable holder parking area to at least one workstation. At least two bound holders are transported to a same workstation. The workstation is coupled to the control device and configured to exchange a container on at least one first bound holder with the bound container on at least one additional second bound holder according to the cargo collection attribute of the bound container, so that consistency of cargo collection attribute of the bound container on at least the first bound holder after exchange is higher than consistency of cargo collection attribute of the bound container on the first bound holder before the exchange.

A second aspect of embodiments of the present disclosure provides a scheduling method, including: determining a bound container and a bound holder according to an order, in which the bound holder is a movable holder carrying the bound container; sending a transporting indication to the handling equipment so that the handling equipment transports all the bound holders to at least one workstation, in which at least two bound holders are transported to the same workstation; sending a tally instruction to the workstation so that the workstation exchange a container on at least one first bound holder with the bound container on at least one additional second bound holder according to the cargo collection attribute of the bound container, so that consistency of cargo collection attribute of the bound container on the first bound holder after exchange is higher than consistency of cargo collection attribute of the bound container on the first bound holder before the exchange.

A third aspect of embodiments of the present disclosure provides a workstation including a first temporary storage position and a first container pick-and-place device. The first temporary storage position is used to place a container, and the container is used to store cargo. The first container pick-and-place device is configured to receive an tally instruction; in response to the tally instruction, exchange a container on at least one first bound holder with the bound container on at least one additional second bound holder through the first temporary storage position, so that consistency of cargo collection attribute of the bound container on the first bound holder after exchange is higher than consistency of the bound container on the first bound holder before the exchange.

### BRIEF DESCRIPTION OF THE DRAWINGS

The following drawings of the present disclosure are hereby used as part of the present disclosure for the understanding of the present disclosure. The accompanying drawings show embodiments of the present disclosure and its description, which are used to explain the principle of the present disclosure.

FIG. 1 is a schematic diagram of a warehousing system provided by some embodiments of the present disclosure;

FIG. 2 is a schematic diagram of a workstation provided by some embodiments of the present disclosure;

FIG. 3 is a schematic diagram of a hub station provided by some embodiments of the present disclosure;

FIG. 4A is a workflow diagram of a warehousing system provided by some embodiments of the present disclosure;

FIG. 4B is a schematic diagram of a scheduling method provided by some embodiments of the present disclosure;

FIG. 5 is a schematic diagram of another scheduling method provided by some embodiments of the present disclosure;

FIG. 6 is a schematic diagram of still another scheduling method provided by some embodiments of the present disclosure;

FIG. 7 is a schematic diagram of yet another scheduling method provided by some embodiments of the present disclosure;

FIG. 8 is a schematic diagram of yet another scheduling method provided by some embodiments of the present disclosure;

FIG. 9 is a schematic diagram of yet another scheduling method provided by some embodiments of the present disclosure; and

FIG. 10 is a schematic diagram of yet another scheduling method provided by some embodiments of the present disclosure.

### DETAILED DESCRIPTION OF THE PRESENT DISCLOSURE

In the description below, a great deal of specific detail is given in order to provide a more thorough understanding of the present disclosure. However, it is obvious to those skilled in the art that the present disclosure can be implemented without one or more of these details. In other examples, some of the technical features that are commonly known in the art are not described, in order to avoid confusion with the present disclosure.

In order to thoroughly understand the present disclosure, a detailed description is provided in the following description. It should be understood that these embodiments are provided in order to make the present disclosure thorough and complete, and to fully convey the ideas of these illustrative embodiments to those skilled in the art. Obviously, the implementation of the present disclosure is not limited to special details familiar to those skilled in the art. The preferred embodiments of the present disclosure are described in detail below, but in addition to these detailed descriptions, the present disclosure may have other embodiments.

It should be noted that the terminology used here is intended only to describe specific embodiments and is not intended to limit illustrative embodiments under the present disclosure. As used herein, the singular form is also intended to include the plural form, unless the context expressly states otherwise. In addition, it should be understood that when the terms “contain” and/or “include” are used in this specification, they indicate the presence of the features, wholes, steps, operations, elements and/or assemblies, but do not exclude the existence or addition of one or more other features, wholes, steps, operations, elements, assemblies and/or combinations thereof.

Ordinal numerals such as “first” and “second” used in the present disclosure are merely identifiers and do not have any other meaning, such as a specific order, etc. Furthermore, for example, the term “first part” does not imply the existence of a “second part” in itself, and the term “second part” itself does not imply the existence of a “first part”.

It should be noted that the terms “up”, “down”, “before”, “after”, “left”, “right”, “inner”, “outer” and similar expressions used in this article are for illustrative purposes only and are not a limitation.

In warehousing and logistics management, the picking is completed according to an order, cargo boxes bound to the order (order boxes) are often scattered on each rack in different positions in the warehouse, and cargo collection work of cargo boxer needs to be completed manually, which leads to a large manual workload and increases the labor cost.

In order to solve the above problem, embodiments of the present disclosure provide a warehousing system, which can automatically place the cargo boxes (such as bound containers) with the same cargo collection attribute on a same or several movable holders (such as a rack) as much as possible, so that the storage position in the storage inventory of the bound containers is regularly distributed, and the development of logistics production work is convenient.

An illustrative embodiment according to the present disclosure is described in more detail below with reference to the accompanying drawings.

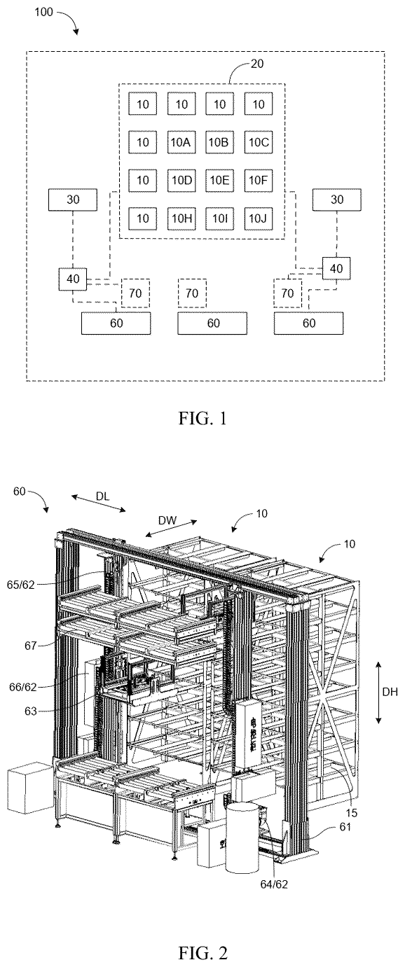

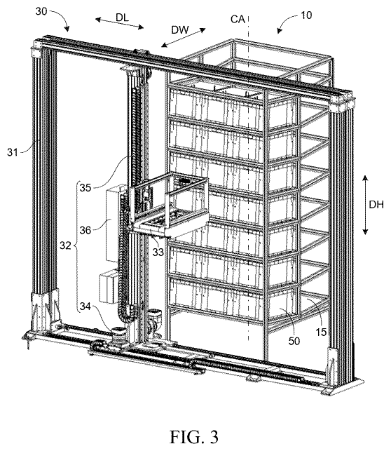

FIG. 1 is a schematic diagram of a warehousing system provided by some embodiments of the present disclosure, FIG. 2 is a schematic diagram of a workstation provided by some embodiments of the present disclosure; and FIG. 3 is a schematic diagram of a hub station provided by some embodiments of the present disclosure. An illustrative description of the warehousing system provided by the embodiments of the present disclosure is provided in conjunction with FIG. 1 to FIG. 3.

In some embodiments, as illustrated in FIG. 1, the warehousing system 100 includes a plurality of movable holders 10, a movable holder parking area 20, at least one handling equipment 40, at least one workstation 60 and a control device (not illustrated in FIG. 1).

In some examples, the movable holder 10 includes a plurality of placement positions 15 (as illustrated in FIG. 2 and FIG. 3) used to place containers 50 (as illustrated in FIG. 3), and containers 50 are used to store cargo. For example, the placement position 15 can be constructed as a cuboid-shaped accommodating space and arranged neatly along a length direction, a width direction, and a height direction of the movable holder 10.

In some examples, the container 50 may be a companion product specially designed for the movable holder 10, or it may be a general cargo box, or it may be a packaging of cargo.

In some examples, the movable holder parking area 20 may include a plurality of parking positions, each parking position can be used to park one movable holder 10. For example, as illustrated in FIG. 1, the plurality of parking positions are neatly arranged in rows and columns.

In some examples, the workstation 60 may include at least one picking station, and the picking station is used to process the container 50. For example, remove an item from the container 50 or put an item into the container 50. That is, the workstation 60 can perform the picking of cargo according to an order.

In some examples, the handling equipment 40, such as the automatic handling equipment 40 (the following embodiment takes the automatic handling equipment 40 as an example for schematic description), is used to transport the movable holder 10 between the movable holder parking area 20 and the workstation 60. For example, the automatic handling equipment 40 can be a transfer robot. The automatic handling equipment 40 can run to the beneath of the movable holder 10, and then the movable holder 10 is pushed upwards off the ground, so that the movable holder 10 can be supported to move. For example, the movable holder 10 can be a rack.

In some examples, the control device is coupled with the workstation 60 and the automatic handling equipment 40 and is used to control operation of the workstation 60 and the automatic handling equipment 40. For example, the control device can control the movement of the automatic handling equipment 40, and can control a process of picking cargo at the workstation 60.

For example, the warehousing system 100 further includes a waiting area 70, and the waiting area 70 may be arranged in an area closer to the workstation 60 than the movable holder parking area 20 and is used to make the movable holder 10 queue up for picking.

In some examples, each workstation 60 is configured with a corresponding waiting area 70. For example, the waiting area 70 can also be seen as part of the workstation 60. The automatic handling equipment 40 can also be used to transport the movable holder 10 between the movable holder parking area 20, the workstation 60 and the waiting area 70.

For example, the warehousing system 100 can also include at least one hub station 30. The hub station 30 is used to adjust a placement position of the plurality of containers 50 on the movable holder 10, including adjusting the position of the plurality of containers 50 on the same movable holder 10, and also including exchanging containers 50 between at least two movable holders 10.

In some examples, the control device is coupled to the hub station 30 and can control the operation of the hub station 30. For example, the control device can control the operation of the hub station 30 to adjust the placement position of the container. For example, the control device can send a transporting instruction to the automatic handling equipment 40 so that the automatic handling equipment 40 transports the movable holder 10 between the movable holder parking area 20, the hub station 30, the workstation 60 and the waiting area 70.

In some embodiments, as illustrated in FIG. 2, the warehousing system includes the workstation. The workstation 60 includes a first support frame 61, a first guiding mechanism 62, a first container pick-and-place device 63 and a first temporary storage position 67.

In some examples, the first temporary storage position 67 is arranged to the first support frame 61. The first guiding mechanism 62 is arranged to the first support frame 61. The first guiding mechanism 62 can move laterally and vertically relative to the first support frame 61. A lateral direction is a DL direction illustrated in FIG. 2 (corresponding to the length direction of the movable holder 10), and a vertical direction is a DH direction illustrated in FIG. 2 (corresponding to the height direction of the movable holder 10).

In some examples, the first container pick-and-place device 63 is arranged to the first guiding mechanism 62, and the first container pick-and-place device 63 can move laterally and vertically relative to the first support frame 61. For example, the first container pick-and-place device 63 can be coupled to the control device. When the automatic handling equipment 40 transport the movable holder 10 to a present work position relative to the first support frame 61 under the control of the control device, the first container pick-and-place device 63 reaches a position corresponding to the placement position 15 by moving laterally and vertically, so that the container 50 can be picked from and placed onto the placement position 15.

In some examples, the first guiding mechanism 62 may be a mechanical arm, for example, the first guiding mechanism 62 may be a mechanical arm capable of automatic operation. The first container pick-and-place device 63 may be arranged at one end of the mechanical arm, and the first container pick-and-place device 63 can be moved in the lateral direction (such as the DL direction) or the vertical direction (the DH direction) through the movement of the mechanical arm.

For example, the first container pick-and-place device 63 has a driving part of a cylinder that can move in a DW direction (the DW direction is perpendicular to the DL direction and the DH direction, corresponding to the width direction of the movable holder 10), so that the container 50 on the placement position 15 can be taken out.

For example, the first guiding mechanism 62 includes a first lateral moving device 64, a first moving rod 65 and a first vertical moving device 66.

The first lateral moving device 64 is arranged to the first support frame 61. The first lateral moving device 64 is coupled to the control device. The first lateral moving device 64 is configured to move laterally relative to the first support frame 61. The first moving rod 65 extends in the vertical direction. The first moving rod 65 is arranged to the first lateral moving device 64, and the first moving rod 65 and the first lateral moving device 64 move laterally synchronously relative to the first support frame 61. The first vertical moving device 66 is arranged to the first moving rod 65. The first vertical moving device 66 is coupled to the control device. The first vertical moving device 66 is configured to move vertically relative to the first moving rod 65. The first container pick-and-place device 63 is arranged to the first vertical moving device 66, and the first container pick-and-place device 63 can move vertically relative to the first moving rod 65. The first container pick-and-place device 63 can move laterally and vertically on the first support frame 61. The first temporary storage position 67 is also used to place the container 50. Therefore, the first container pick-and-place device 63 may move the container 50 between different placement positions 15 or between the placement position 15 and the first temporary storage position, thereby adjusting the placement position of the container 50 on the same movable holder 10 or moving the container 50 between the plurality of movable holders 10.

In some embodiments, as illustrated in FIG. 3, the hub station 30 includes a second support frame 31, a second guiding mechanism 32, a second container pick-and-place device 33 and a second temporary storage position (not illustrated in FIG. 3). For example, the second temporary storage position may be arranged to the second support frame 31 or the second guiding mechanism 32. It should be noted that the hub station 30 has a similar structure to the workstation 60.

In some examples, the second guiding mechanism 32 is arranged to the second support frame 31. The second guiding mechanism 32 can move laterally and vertically relative to the second support frame 31. The second container pick-and-place device 33 is arranged to the second guiding mechanism 32, so that the second container pick-and-place device 33 can move laterally and vertically relative to the second support frame 31. The second container pick-and-place device 33 is coupled to the control device. When the automatic handling equipment 40 transports the movable holder 10 to the present work position relative to the second support frame 31 under the control of the control device, the second container pick-and-place device 33 reaches a position corresponding to the placement position 15 by moving laterally and vertically, so that the container 50 can be picked from and placed onto the placement position 15.

In some examples, the second guiding mechanism 32 may be a mechanical arm, for example, the second guiding mechanism 32 may also be a mechanical arm capable of automatic operation. The second container pick-and-place device 33 may be arranged at one end of the mechanical arm, and the second container pick-and-place device 33 can move in the lateral direction or the vertical direction through the movement of the mechanical arm.

In some examples, the second guiding mechanism 32 includes a second lateral moving device 34, a second moving rod 35 and a second vertical moving device 36. The second lateral moving device 34 is arranged to the second support frame 31. The second lateral moving device 34 is coupled to the control device. The second lateral moving device 34 is configured to move laterally relative to the second support frame 31. The second moving rod 35 extends in the vertical direction. The second moving rod 35 is arranged to the second lateral moving device 34, so that the second moving rod 35 and the second lateral moving device 34 move laterally synchronously relative to the second support frame 31. The second vertical moving device 36 is arranged to the second moving rod 35. The second vertical moving device 36 is coupled to the control device. The second vertical moving device 36 is configured to move vertically relative to the second moving rod 35. The second container pick-and-place device 33 is arranged to the second vertical moving device 36, so that the second container pick-and-place device 33 can move vertically relative to the second moving rod 35. Therefore, the second container pick-and-place device 33 can move laterally and vertically on the second support frame 31. The second temporary storage position is also used to place the container 50. Therefore, the second container pick-and-place device 33 may move the container 50 between different placement positions 15 or between the placement position 15 and the second temporary storage position, thereby adjusting the placement position of the container 50 on the same movable holder 10 or moving the container 50 between the plurality of movable holders 10.

It should be noted that the hub station 30 may only include one second guiding mechanism 32, or, when a volume of the second support frame 31 is large, the hub station 3 may also be provided with a plurality of second guiding mechanisms 32 simultaneously. That is, it is possible to integrate a plurality of hub stations 30, which makes it possible to simultaneously allow more movable holders 10 to perform tallying.

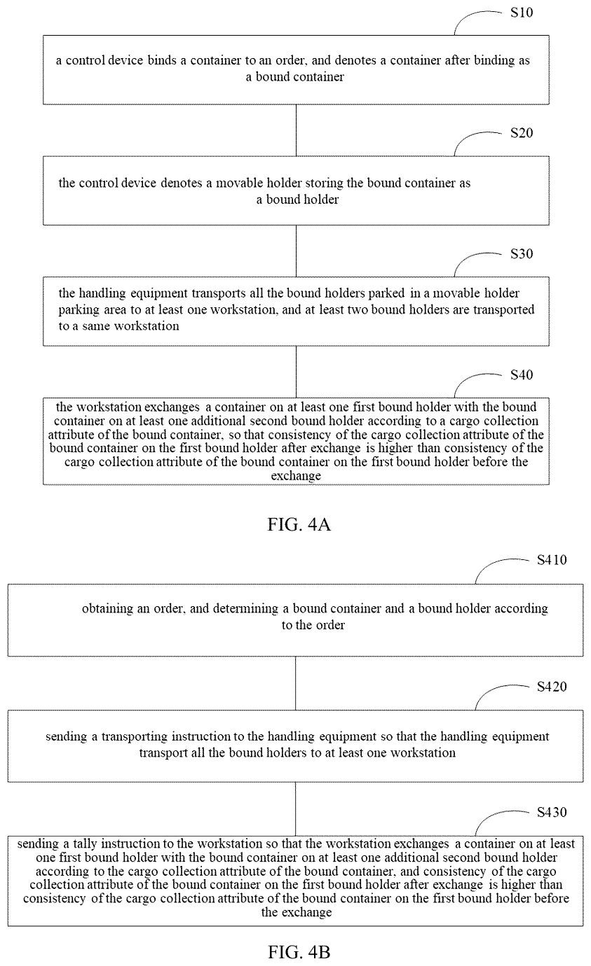

FIG. 4A is a workflow diagram of a warehousing system provided by some embodiments of the present disclosure. As illustrated in FIG. 4A, the warehousing system 100 provided in the embodiment of the present disclosure is configured to complete the operation of the following steps:

In step S10, the control device binds a container to an order and denotes the container after binding as a bound container.

In step S20, the control device denotes a movable holder containing the bound container as a bound holder.

In step S30, the handling equipment transports all the bound holders parked in a movable holder parking area to at least one workstation, and at least two bound holders are transported to a same workstation.

In step S40, the workstation exchanges the container on at least one first bound holder with the bound container on at least one additional second bound holder according to a cargo collection attribute of the bound container, so that consistency of cargo collection attribute of the bound container on at least the first bound holder after the exchange is higher than consistency of cargo collection attribute of the bound container on the first bound holder before the exchange.

In some examples, the process of step S10 and step S20 may also include determining the bound container and the bound holder according to the order. The bound holder is a movable holder carrying the bound container. That is to say, according to the order, after the container is bound to the order, the bound container can be determined; and then, according to the determined bound container, the bound holder is determined.

In some embodiments, the workstation 60 in the warehousing system 100 is configured to exchange the bound container on at least one first bound holder with the bound container on at least one additional second bound holder according to the cargo collection attribute of the bound container, so that the consistency of cargo collection attribute of the bound container on the first bound holder after the exchange is higher than the consistency of cargo collection attribute of the bound container on the first bound holder before the exchange; Moreover, the consistency of cargo collection attribute of the bound container on the second bound holder after the exchange is higher than the consistency of the bound container on the second bound holder before the exchange.

The workstation 60 in the warehousing system 100 provided in the embodiments of the present disclosure may improve the consistency of cargo collection attributes of the first bound holder and the second bound holder by exchanging the bound containers on the first bound holder and the second bound holder according to the cargo collection attribute of the container, thereby improving the tally efficiency.

In some embodiments, the container on the first bound holder are exchanged with the bound container on the second bound holder so that a total cargo collection similarity degree totalSimi after the exchange has a maximum value. The total cargo collection similarity degree totalSimi is determined according to the following formula (1).

$$totalSimi = {\sum }_{i = 1}^{N - 1} {\sum }_{j = i + 1}^{N} [ {Simi}_{ij} \cdot \frac{{She}_{ij}}{{Dis}_{ij} + 1} - max ( 1 - {Simi}_{ij} , 0 ) \cdot {She}_{ij} \cdot P ] ; \qquad ( 1 )$$

In formula (1), i is a positive integer and j is a positive integer. P is a constant, and P can be used to indicate a penalty value when bound containers with different values of cargo collection attribute are placed on the same movable holder 10 (bound holder). N is the number of all bound containers, and N is a positive integer. Disᵢⱼ is a distance between the bound holder where the ith bound container is located and the bound holder where the jth bound container is located after the container exchange, i.e., a distance between the parking positions of the two bound containers (e.g., a distance between center points of the two parking positions).

In some examples, after container exchange, when the ith bound container and the jth bound container are on the same bound holder, a value of Sheᵢⱼ is 1; when the ith bound container and the jth bound container are not on the same bound holder, the value of Sheᵢⱼ is 0.

In some examples, Simiᵢⱼ is a same rate of cargo collection attribute of the ith bound container and the jth bound container, the same rate Simiᵢⱼ of cargo collection attribute is calculated as illustrated in formula (2):

$${Simi}_{ij} = {\prod }_{m = 1}^{M} {At}_{ijm} ; \qquad ( 2 )$$

In formula (2), m is a positive integer. M is a dimension of a specified cargo collection attribute, and M is a positive integer. When the cargo collection attribute of the mth dimension of the ith bound container is the same as the cargo collection attribute of the mth dimension of the jth bound container, a value of Atᵢⱼₘ is 1; when the cargo collection attribute of the mth dimension of the ith bound container is different from the cargo collection attribute of the mth dimension of the jth bound container, the value of Atᵢⱼₘ is 0.

In some embodiments, the cargo collection attribute includes at least one of courier company, destination, cargo owner, supplier, commodity type, commodity storage temperature, commodity relationship, commodity grade, or delivery time.

For example, the cargo collection attribute can be determined according to different cargo collection purposes or cargo collection needs. For example, depending on the cargo collection purpose or cargo collection need, at least one cargo collection attribute from the courier company, destination, cargo owner, supplier, commodity type, commodity storage temperature, commodity relationship, commodity grade, and delivery time can be specified as a specified cargo collection attribute, and the container exchange operation can be performed according to the specified cargo collection attribute.

In some examples, the number of the specified cargo collection attribute determines a dimension of the specified cargo collection attributes. For example, when considering both destination and delivery time, the specified cargo collection attribute can include destination and delivery time, and the specified cargo collection attribute has a dimension of 2, that is, M=2, and when considering both supplier, commodity type, and commodity grade, the specified cargo collection attribute includes supplier, commodity type, and commodity grade, and the specified cargo collection attribute has a dimension of 3, that is, M=3.

The embodiments of the present disclosure can realize that a plurality of bound containers with the same values on the specified M cargo collection attributes are placed on one or more movable holders in a centralized manner, to improve the tally efficiency and facilitate development of logistics work.

For example, the values of the same cargo collection attribute can be different, that is, a cargo collection attribute can have a plurality of different values. For example, if the cargo collection attribute is the destination, the corresponding value of cargo collection attribute is different depending on the destination. For example, when the destinations of cargo are Beijing, Shanghai, and Guangzhou, the values of the destination of cargo collection attribute can be Beijing, Shanghai, and Guangzhou respectively. That is, Beijing, Shanghai, and Guangzhou are different values for the destination of cargo collection attribute. For example, when the cargo collection attribute is delivery time, different orders may have different delivery times. For example, if the delivery time can be 8:00, 9:00, and 10:00 respectively, then 8:00, 9:00, and 10:00 are different values for the delivery time of cargo collection attribute.

In some examples, the same rate Simiᵢⱼ of cargo collection attribute is either 1 or 0. When the value of Simiᵢⱼ is 1, it means that all the values of the specified M cargo collection attributes of the ith bound container and the jth bound container are the same, in this case, the value of the total cargo collection similarity degree totalSimi is large. Conversely, when the value of Simiᵢⱼ is 0, it means that at least one of the values of the specified M cargo collection attributes of the ith bound container and the jth bound container is different, in this case, the value of total cargo collection similarity degree totalSimi is small.

The embodiments of the present disclosure provide the warehousing system 100 that can automatically collect cargo according to the cargo collection attribute of a hit container (such as an order box), and try to place the order boxes with the all the values of the specified M cargo collection attributes being the same on a same (or several) movable holder 10, thereby facilitating development of the later logistics work. For example, the warehousing system 100 can perform tally according to the cargo collection attributes such as the delivery destination, the delivery time, and the hit containers (such as the order boxes) with the same delivery destination and the delivery time are concentrated on the same (or several) movable holder 10, thereby facilitating the subsequent delivery step.

In order to make the value of the total cargo collection similarity degree totalSimi as large as possible, in some embodiments, the control device in the warehousing system 100 is configured to select a container 50 on the bound holder to bind with the order, so that a coincidence degree avgSimi of the order relative to the cargo collection attribute of the bound holder has a maximum value, and the coincidence degree avgSimi of cargo collection attribute can be calculated according to formula (3):

$$avgSimi = \frac{{\sum }_{k = 1}^{K} ( 2 {\prod }_{m = 1}^{M} {Attri}_{k m} - 1 )}{K} ; \qquad ( 3 )$$

In formula (3), k is a positive integer and m is a positive integer. K is the number of all bound containers on a certain bound holder, and K is a positive integer. M is the dimension of the specified cargo collection attribute, and M is a positive integer.

In some examples, when the value of cargo collection attribute of the nth dimension of the order is the same as the value of cargo collection attribute of the mth dimension of the kth bound container on the bound holder, the value of Attriₖₘ is 1. When the value of cargo collection attribute of the mth dimension of the order is different from the value of cargo collection attribute of the mth dimension of the kth bound container on the bound holder, the value of Attriₖₘ is 0.

From formula (3), it can be seen that when more than half of the bound containers on the bound holder have the cargo collection attribute consistent with the order, the value of avgSimi is greater than 0; when exactly half of the bound containers on the bound holder have the cargo collection attribute consistent with the order, the value of avgSimi is equal to 0; and when less than half of the bound containers on the bound holder have the cargo collection attribute consistent with the order, the value of avgSimi is less than 0.

In some examples, when the order selects the container 50 to which it is bound, the control device first selects a container 50 on the bound holder. The control device measures the coincidence degree of cargo collection attribute between all bound containers on each bound holder and the order, and preferably selects the bound holder with the highest coincidence degree (a case where the values of cargo collection attribute are the same at most), so that the consistency of cargo collection attribute of all bound containers on the bound holder is as high as possible.

In some embodiments, the control device in the warehousing system 100 is configured to, in a case where the coincidence degree avgSimi of cargo collection attribute of the order relative to relative to all the bound holders is less than zero, if the plurality of movable holders 10 includes a non-bound holder, the container 50 on the non-bound holder is bound to the order; if the plurality of movable holders 10 are all bound holders, the container 50 on the bound holder with a largest coincidence degree avgSimi of cargo collection attribute is bound to the order.

For example, when the order relative to each bound holder has the same values of the specified cargo collection attribute as a few bound containers on the bound holder, the control device preferably selects the container 50 on the non-bound holder to bind to the order. In this way, the consistency of cargo collection attribute of the bound container on the existing bound holder cannot be affected, and when the corresponding container is assigned to the order, the order with the consistent cargo collection attribute and the containers bound to it can be concentrated on the same movable holder 10, to create convenient conditions for subsequent tally.

In order to improve the tally efficiency, the warehousing system 100 needs to minimize the number of times the bound container is moved on the basis of ensuring the maximum value of total cargo collection similarity degree totalSimi.

In some implementations, the workstation 60 in the warehousing system 100 is configured to: exchange the container 50 on at least one first bound holder with the bound container on at least one additional second bound holder so that a container movement value drSCh after the exchange has a minimum value. The container movement value drSCh is calculated according to formula (4):

$$drSCh = {\sum }_{i = 1}^{N} {chaShe}_{i} ; \qquad ( 4 )$$

In formula (4), i is a positive integer, N is the number of all bound containers, and N is a positive integer. When the movable holder used to place the ith bound container is adjusted, the value of chaSheᵢ is 1; when the movable holder used to place the ith bound container is not adjusted, the value of chaSheᵢ is 0.

FIG. 4B is a schematic diagram of a scheduling method provided by some embodiments of the present disclosure. In some examples, the scheduling method can be executed by the warehousing system 100 in the above embodiment, for example, by the control device in the warehousing system 100. The scheduling method provided by the embodiments of the present disclosure is described below in conjunction with FIG. 4B. As illustrated in FIG. 4B, the method includes the steps illustrated below.

In step S410, an order is obtained, and a bound container and a bound holder are determined according to the order.

The bound holder is a movable holder carrying the bound container.

In some examples, determining the bound container and the bound holder according to the order may include binding a container 50 to the order and determining the container 50 after binding as the bound container, and determining a movable holder 10 storing the bound container as the bound holder. For example, a container (for example, an order box) to be bound to the order can be determined according to an order need and the cargo in the container.

For example, the number of bound containers determined by the order can be plural, and the number of bound holders carrying the plurality of bound containers can be plural.

In step S420, a transporting instruction is sent to the handling equipment so that the handling equipment transports all bound holders to at least one workstation.

In some examples, the handling equipment 40 transports all bound holders parked in the movable holder parking area to at least one workstation 60 according to the transporting instruction sent by the control device.

For example, the transporting instruction can include information of the bound holder needing to be transported by the automatic handling equipment 40 and the information of the transporting route.

In some examples, the control device may send the transporting instruction to the automatic handling equipment 40, and the automatic handling equipment 40 receives the transporting instruction and, according to the transporting instruction, transports the plurality of bound holders from the movable holder parking area to the workstation 60. For example, the automatic handling equipment 40 can transport at least two bound holders from the plurality of bound holders to a same workstation 60.

In step S430, a tally instruction is sent to the workstation so that the workstation exchanges the container on at least one first bound holder with the bound container on at least one additional second bound holder according to the cargo collection attribute of the bound container, so that the consistency of cargo collection attribute of the bound container on the first bound holder after exchange is higher than the consistency of cargo collection attribute of the bound container on the first bound holder before the exchange.

The first bound holder and the second bound holder are two different bound holders in the plurality of bound holders.

In some examples, it is possible to tally at workstation 60 according to the cargo collection attribute of the container, and to place bound containers with the same cargo collection attribute on one movable holder 10.

In some embodiments, the step S430 may include: sending a tally instruction to the workstation 60 so that the workstation 60 exchanges the bound container on the first bound holder with the bound container on the second bound holder according to the cargo collection attribute of the bound container, so that the consistency of cargo collection attribute of the bound container on the first bound holder after the exchange is higher than the consistency of cargo collection attribute of the bound container on the first bound holder before the exchange, and the consistency of cargo collection attribute of the bound container on the second bound holder after the exchange higher than the consistency of cargo collection attribute of the bound container on the second bound holder before the exchange.

The following describes a container exchange process between the bound container on at least the first bound holder and the bound container on at least one second bound container in step S430 in conjunction with the accompanying drawing.

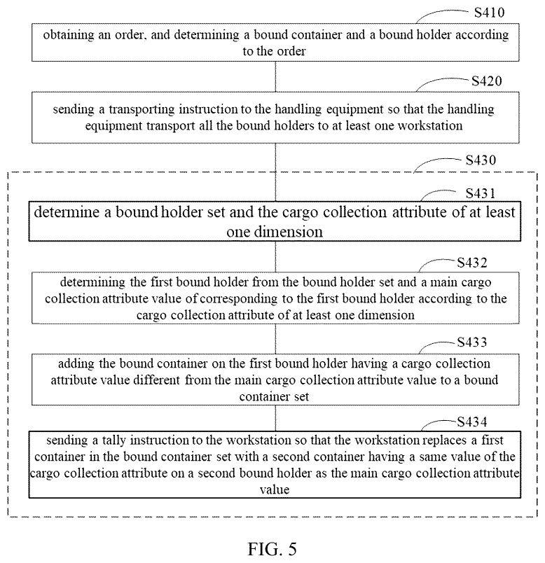

FIG. 5 is a schematic diagram of another scheduling method provided by some embodiments of the present disclosure. As illustrated in FIG. 5, the above step S430 includes the steps described below.

In step S431, a bound holder set and a cargo collection attribute of at least one dimension are determined.

In some examples, the bound holder set can include a plurality of bound holders. For example, an initial value of the bound holder set can include all bound holders.

In some examples, at least one cargo collection attribute can be determined from a plurality of cargo collection attributes (such as courier company, destination, cargo owner, supplier, commodity type, commodity storage temperature, commodity relationship, commodity grade, and delivery time) according to the cargo collection purposes or needs, and a dimension of cargo collection attribute can be determined according to the number of determined cargo collection attributes.

For example, one cargo collection attribute can be determined as the specified cargo collection attribute from the plurality of cargo collection attributes, that is, the dimension of cargo collection attribute is 1. Alternatively, two (or more) cargo collection attributes can be determined from the plurality of cargo collection attributes as the specified cargo collection attributes, that is, the dimension of cargo collection attribute is 2.

In step S432, the first bound holder and a main cargo collection attribute value corresponding to the first bound holder are determined from in the bound holder set according to the cargo collection attribute of at least one dimension.

In some examples, the first bound holder is a movable holder needing to perform a container exchange in the plurality of bound holders. For example, the first bound holder can be a bound holder needing to be prioritized for cargo collection, such as improving the consistency of cargo collection attribute.

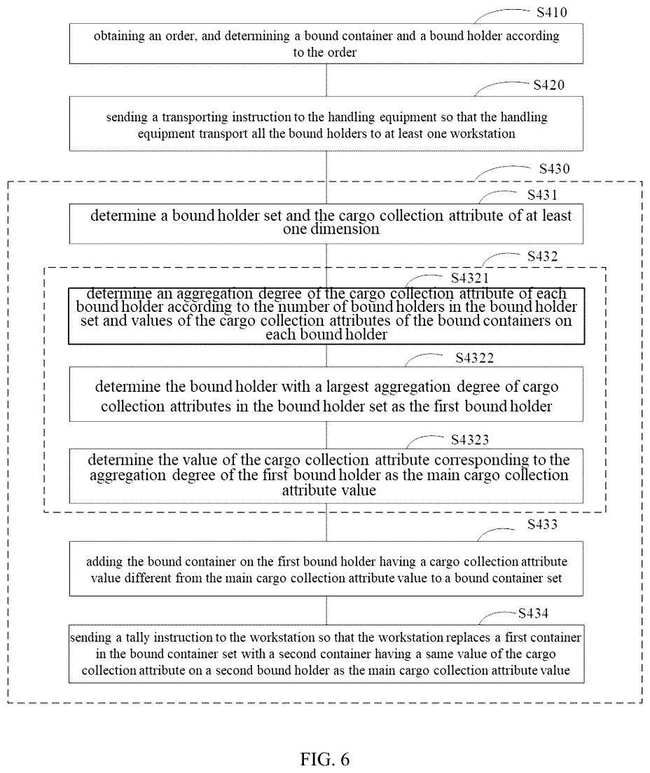

FIG. 6 is a schematic diagram of still another scheduling method provided by some embodiments of the present disclosure. The process of determining the first bound holder and the process of determining the main cargo collection attribute value of the first bound holder are illustrated below in conjunction with FIG. 6. As illustrated in FIG. 6, the above step S432 includes the steps illustrated below.

In step S4321, an aggregation degree of cargo collection attribute of each bound holder is determined according to the number of bound holders in the bound holder set and the value of cargo collection attribute of the bound container on each bound holder.

In some embodiments, the same rate of at least one cargo collection attribute of each bound holder can be determined according to the number of bound holders and the value of cargo collection attribute of each bound container on each bound holder, and a maximum value in the same rates of at least one cargo collection attribute is determined as the aggregation degree of cargo collection attribute of each bound holder.

In some examples, the same rate of cargo collection attribute can be determined by dividing the number of bound holders in the bound holder set (for example, K) by the number of bound containers having the same values for all cargo collection attributes of the M dimensions in the all bound containers on the first bound holder. Having the same values for all cargo collection attributes can include the value of the cargo collection attribute on each dimension in the cargo collection attribute on at least one dimension being the same.

For example, in a case where the specified cargo collection attributes are destination and cargo owner, that is, the dimension of cargo collection attribute is 2, if there are 10 bound containers on a certain bound holder (for example, K=10). The values of the specified cargo collection attributes of the order corresponding to the bound containers No. 1-5 are: destination—Beijing, cargo owner—AAA; the values of the specified cargo collection attributes of the order corresponding to the bound containers No. 6-8 are: destination—Shanghai, cargo owner—BBB; and the values of the specified cargo collection attributes of the order corresponding to the bound container No. 9-10 is: destination—Shanghai, cargo owner—AAA. The bound holder has the three same rates of cargo collection attribute. A first same rate sart 1 of cargo collection attribute contributed by the bound containers No. 1-5=5/10=0.5, a second same rate sart 2 of cargo collection attribute contributed by the bound containers No. 6-8=3/10=0.3, and a third same rate sart 3 of cargo collection attribute contributed by the bound containers No. 9-10=2/10=0.2.

In the above example, the first same rate sart 1 of cargo collection attribute contributed by the bound containers No. 1-5 is the largest, so the value of the aggregation degree of cargo collection attribute of the bound holder can be determined as sart1, that is, the aggregation degree of cargo collection attribute of the bound holder is 0.5.

In step S4322, the bound holder with the largest aggregation degree of cargo collection attribute in the bound holder set is determined as the first bound holder.

In some examples, the aggregation degree of cargo collection attribute of the bound holder can reflect the current consistency of cargo collection attribute of the bound holder, and the larger the aggregation degree of cargo collection attribute, the more consistent the value of cargo collection attribute of each bound container on the bound holder. Therefore, the bound holder with the largest aggregation degree of cargo collection attribute in the bound holder set can be determined as the first bound holder, and the first bound holder can be guaranteed to be the bound holder with good (or best) consistency of cargo collection attribute in the plurality of bound holders.

For example, the bound holder set includes three bound holders with aggregation degrees of 0.5, 0.6, and 0.7, respectively. The bound holder corresponding to the aggregation degree of cargo collection attribute of 0.7 can be determined as the first bound carrier, i.e., the bound holder prioritized for cargo collection.

In step S4323, the value of cargo collection attribute corresponding to the aggregation degree of cargo collection attribute of the first bound holder is determined as the main cargo collection attribute value.

For example, in the example of step S4321, if the aggregation degree of cargo collection attribute of the first bound holder is 0.5, the value of the cargo collection attribute corresponding to the aggregation degree of cargo collection attribute of 0.5 is destination-Beijing and the cargo owner-AAA, that is, the value of cargo collection attribute: destination-Beijing and the cargo owner-AAA can be determined as the main cargo collection attribute value.

In step S433, the bound container having a value of cargo collection attribute on the first bound holder different from the main cargo collection attribute value is added to a bound container set.

In some examples, the first bound holder includes the plurality of bound containers, and there may be at least one bound container in the plurality of bound containers having a value different from the main cargo collection attribute value, and at least one bound container can be added to the bound container set.

For example, in the example of the above step S4321, the value of cargo collection attribute of the bound containers No. 6-10 is different from the main cargo collection attribute value (for example, the value of cargo collection attribute of the bound containers No. 1-5), so the bound containers No. 6-10 (e.g., 5 bound containers) can be added to the bound container set.

In step S434, a tally instruction is sent to the workstation so that the workstation replaces the first container in the bound container set with a second container having a value of cargo collection attribute on the second bound holder the same value as the main cargo collection attribute value.

For example, the first container can be any container in the bound container set, and the second bound holder is a holder in the bound holder set different from the first bound holder.

In some examples, the first container on the first bound holder is exchanged with the second container on the second bound holder, i.e., the first container on the first bound holder that reduces the consistency of cargo collection attribute of the first bound holder is exchanged with the second container on the second bound holder that improves the consistency of cargo collection attribute the first bound holder.

In some examples, the second bound holder can be a bound holder in the bound holder set other than the first bound holder. Other than the first bound holder, there may be a plurality of bound holders in the bound holder set, and the second bound holder needs to be determined from the plurality of bound holders.

In some embodiments, when the bound holder set includes a plurality of third bound holders, an coincidence degree of cargo collection attribute of each third bound holder and the first container is determined according to the number of bound containers on each third bound holder, the value of cargo collection attribute of each bound container on each third bound holder, and the value of cargo collection attribute of the first container; and the third bound holder with the highest coincidence degree of cargo collection attribute is determined as the second bound holder.

In some examples, the third bound holder is different from the first bound holder.

In some examples, the coincidence degree tcSimi of cargo collection attribute between the third bound holder and the first container can be calculated according to the following formula (5):

$$tcSimi = \frac{{\sum }_{k = 1}^{K o} ( 2 {\prod }_{m = 1}^{M} {Attr}_{k m} - 1 )}{Ko} ; \qquad ( 5 )$$

In formula (5), k is a positive integer and m is a positive integer. Ko is the number of all bound containers on the third bound holder, and Ko is a positive integer. M is the dimension of the specified cargo collection attribute, and M is a positive integer. When the value of cargo collection attribute of the first container in the mth dimension is the same as the value of cargo collection attribute of the kth bound container on the third bound holder in the mth dimension, a value of Attrₖₘ is 1; when the value of cargo collection attribute of the first container in the mth dimension is different from the value of cargo collection attribute of the kth bound container on the third bound holder in the mth dimension, the value of Attrₖₘ is 0.

Through the above formula (5), the coincidence degree tcSimi of cargo collection attribute between each third bound holder and the first container can be determined, and then the third bound holder corresponding to the maximum value of the coincidence degree of cargo collection attribute tcSimi is determined as the second bound holder.

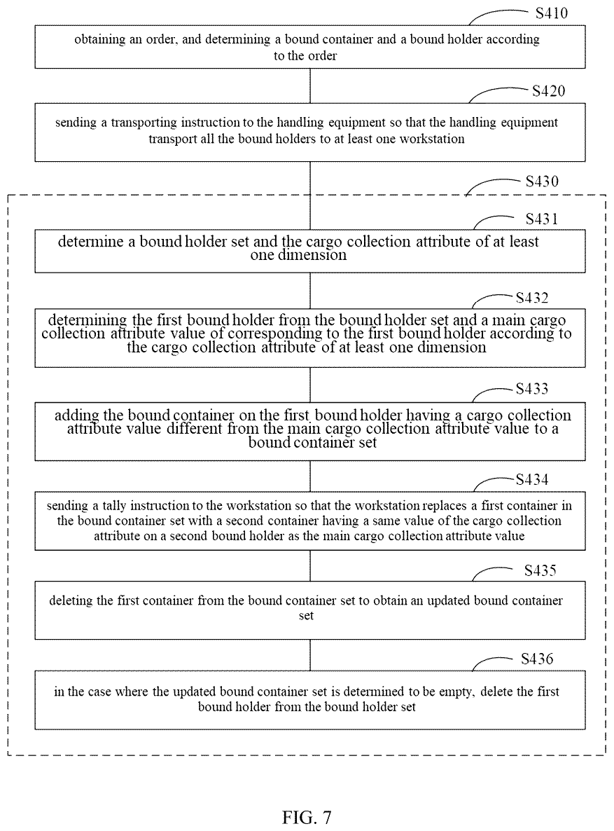

FIG. 7 is a schematic diagram of yet another scheduling method provided by some embodiments of the present disclosure, as illustrated in FIG. 7, and after the above step S434, the scheduling method further includes a step described below.

In step S435, the first container is deleted from the bound container set to obtain an updated bound container set.

In some examples, after exchanging the first container with the second container, and the first container is deleted from the bound container set to obtain the updated bound container set. Then continue to perform step S434 in the above embodiment, that is, take out another bound container from the bound containers and replace it with a bound container having a value of cargo collection attribute the same as the main cargo collection attribute value on the second bound holder until the updated bound container set is empty.

In step S436, in the case where it is determined that the updated bound container set is empty, the first bound holder is deleted from the bound holder set.

When determining that the bound container set is empty, the first bound holder can be removed from the bound holder set, and the step S432 in the above embodiment is continued until only one bound holder remains in the bound holder set, and the container exchange process is stopped, to realize the replacement of container on the at least first bound holder and bound container on the at least second bound holder, and improve the consistency of cargo collection attribute of each bound container in the first bound holder.

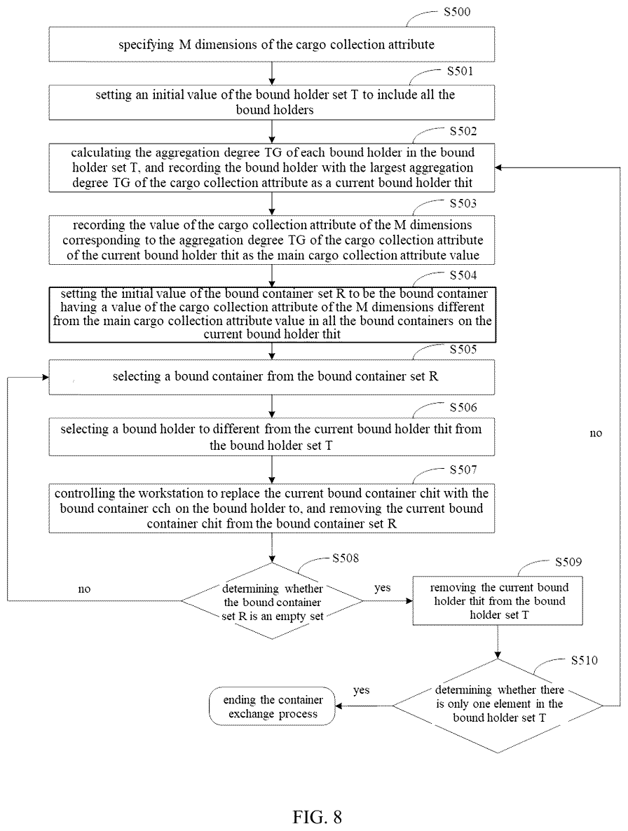

FIG. 8 is a schematic diagram of yet another scheduling method provided by some embodiments of the present disclosure. As illustrated in FIG. 8, when the bound containers are aggregated at the level of the bound holders (that is, when a more optimal bound holder is selected for the bound containers), the control device in the warehousing system 100 is configured to: perform the following container exchange process according to a greedy algorithm so that the bound containers are exchanged among the bound holders, that is, the final position of the bound containers is determined, that is, determining which bound holder the bound containers will finally be placed onto.

In step S500, M dimensions of cargo collection attribute are specified, and then step S501 is performed.

In step S501, an initial value of the bound holder set T set to include all bound holders, and then step S502 is performed.

In step S502, an aggregation degree TG of cargo collection attribute of each bound holder in the bound holder set T is calculated, and the bound holder with a largest aggregation degree TG of cargo collection attribute is recorded as a current bound holder thit, and then step S503 is performed.

The aggregation degree of cargo collection attributes of the tth bound holder in the bound holder set T is recorded as TGt; the aggregation degree TGt of cargo collection attribute is a maximum value of the same rate sart of cargo collection attribute of the tth bound holder. The same rate sart of cargo collection attribute is the number of bound containers having the same values for all cargo collection attributes of the M dimensions in all K bound containers of the tth bound holder divided by a value of K.

For example, the cargo collection attributes that need to be considered at the same time are the destination and the cargo owner, that is, the specified M (for example, M=2) cargo collection attributes are the destination and the cargo owner; If there are 10 bound containers on a certain bound holder (e.g. K=10). The value of the specified cargo collection attribute of the order corresponding to the bound container No. 1-5 is: destination—Beijing, cargo owner—AAA; the value of the specified cargo collection attribute of the order corresponding to the bound container No. 6-8 is: destination—Shanghai, cargo owner—BBB; and the value of the specified cargo collection attribute of the order corresponding to the bound container No. 9-10 is: destination—Shanghai, cargo owner—AAA. The bound holder has three same rates of cargo collection attribute. A first same rate sart 1 of cargo collection attribute contributed by the bound containers No. 1-5=5/10=0.5, a second same rate sart 2 of cargo collection attribute contributed by the bound containers No. 6-8=3/10=0.3, and a third same rate sart 3 of cargo collection attribute contributed by the bound containers No. 9-10=2/10=0.2 The first same rate sart 1 of cargo collection attribute contributed by the bound containers No. 1-5 is the largest, so the aggregation degree TG of cargo collection attribute of the bound holder is sart1, that is, 0.5.

Therefore, the aggregation degree TG of cargo collection attribute of the bound holder can reflect the current consistency of cargo collection attribute of the bound holder, and the larger the value of TG, the more consistent the value of cargo collection attribute of each bound container on the bound holder. That is, the current bound holder thit is the bound holder with good (or best) consistency of cargo collection attribute.

In step S503, the value of cargo collection attribute on M specified dimensions corresponding to the aggregation degree TG of cargo collection attribute of the current bound holder thit is recorded as the main cargo collection attribute value, and then step S504 is performed.

For example, in the example of the above step S502, the main cargo collection attribute value can be: destination-Beijing, cargo owner-AAA.

In step S504, the initial value of the bound container set R is set to include the bound container having a value of cargo collection attribute of the M dimensions different from the main cargo collection attribute value in all the bound containers on the current bound holder thit, and then step S505 is performed.

For example, in the example of above steps S502 and S503, the initial value of the bound container set R can be those bound containers having the cargo collection attribute unable to meet the destination of Beijing and the cargo owner of AAA at the same time in all bound containers on the current bound holder thit, that is, the initial value of the bound container set R includes the bound containers No. 6-10.

In step S505, a bound container is selected from the bound container set R, and recorded as a current bound container chit, and then step S506 is performed.

For example, any bound container can be selected from the current bound container set (for example, any bound container in the bound containers No. 6-10), for example, the current bound container chit can be a bound container with the cargo collection attribute as the destination of Shanghai and the cargo owner of AAA (for example, the bound container No. 9).

In step S506, a bound holder to different from the current bound holder thit is selected from the bound holder set T, and then step S507 is performed.

In some examples, the bound holder to includes the bound container cch having the value of cargo collection attribute on M specified dimensions the same as the main cargo collection attribute value. For example, the bound holder to include at least one bound container with the cargo collection attribute as the destination of Beijing and the cargo owner of AAA, such as the bound container cch.

In step S507, the workstation is controlled to replace the current bound container chit with the bound container cch on the bound holder to, the current bound container chit is removed from the bound container set R, and then step S508 is performed.

For example, the bound container cch with the destination of Beijing and the cargo owner of AAA on the bound holder to can be exchanged with the current bound container chit with the destination of Shanghai and the cargo owner of AAA on the current bound holder thit, so that as many bound containers as possible on the current bound holder thit are of the destination of Beijing and the cargo owner of AAA (the value of the specified cargo collection attribute is the same).

In step S508, it is determined whether the bound container set R is an empty set.

If the bound container set R is empty, step S509 is continued to perform, and if the bound container set R is not empty, step S505 is continued to perform.

For example, the bound container unable to meet the destination of Beijing and cargo owner of AAA at the same time on the current bound holder thit is replaced with the bound container with the destination of Beijing and the cargo owner of AAA in turn, to improve the consistency of cargo collection attribute of the bound container on the current bound holder thit.

In step S509, the current bound holder thit is removed from the bound holder set T, and then step S510 is performed.

In step S510, it is determined whether there is only one element in the bound holder set T.

If there is only one element in the bound holder set T, the container exchange process is ended; and If there is not only one element in the bound holder set T, step S502 is continued to perform.

Through the above-mentioned step S501 to the step S510, the warehousing system 100 can start from the bound holder with the best consistency of cargo collection attribute (i.e., the current bound holder thit), determine the value of cargo collection attribute with the largest statistical count as the main cargo collection attribute value, aggregate the bound container with the main cargo collection attribute value as the standard, and complete the aggregation of the bound container for each bound holder according to its main cargo collection attribute value, reducing the number of times the bound container is moved.

In some embodiments, the control device in the warehousing system 100 is configured to select the bound holder to from the bound holder set T, so that the coincidence degree tcSimi of cargo collection attribute between the bound holder to and the current bound container chit is the highest. The coincidence degree tcSIMI of cargo collection attributes is calculated according to the following formula (5):

$$tcSimi = \frac{{\sum }_{k = 1}^{K o} ( 2 {\prod }_{m = 1}^{M} {Attr}_{km} - 1 )}{Ko} ; \qquad ( 5 )$$

In formula (5), k is a positive integer and m is a positive integer. Ko is the number of all bound containers on the bound holder to, and Ko is a positive integer. M is the dimension of the specified cargo collection attribute, and M is a positive integer. When the value of cargo collection attribute of the mth dimension of the current bound container chit is the same as the value of cargo collection attribute of the mth dimension of the kth bound container on the bound holder to, a value of Attrₖₘ is 1. If the value of cargo collection attribute of the mth dimension of the current bound container chit is different from the value of cargo collection attribute of the kth bound container on the bound holder to, the value of Attrₖₘ is 0.

For example, when the bound holder set T includes a plurality of bound holders to with the bound container having a value of cargo collection attribute of M specified dimensions the same as the main cargo collection attribute value (i.e., the bound holders to are not unique), the warehousing system 100 finds the bound holder with the highest coincidence degree tcSimi of cargo collection attribute relative to the current bound container chit from the plurality of bound holders to according to the above formula (5), and replaces the bound container cch on the bound holder with the current bound container chit.

After replacing the current bound container chit with the bound container cch on the bound holder to, the consistency of cargo collection attribute of each bound container on the bound holder to will be large, that is the consistency of cargo collection attribute of the current bound holder thit and the bound holder to is improved.

For example, the control device in the warehousing system 100 is configured to perform steps S501 through S510 several times repeatedly. Each time it is performed, the aggregation of bound containers on the bound holder (consistency of cargo collection attribute) is optimized until the optimization effect reaches the desired goal or there is no room for further optimization.

Each bound holder in the warehousing system 100 provided by the embodiments of the present disclosure aggregates bound containers according to the cargo collection attribute. In order to further facilitate the subsequent logistics work, the warehousing system 100 can also collect cargo in a dimension of the parking position.

In some embodiments, the control device in the warehousing system 100 is configured to, after the workstation 60 exchanges the container 50 on at least one first bound holder with the bound container on at least one additional second bound holder, and adjust the position of the bound holder in the movable holder parking area 20 according to the cargo collection attribute.

In some examples, the control device adjusting the position of the bound holder in the movable holder parking area 20 includes: the control device determining a target position of the bound holder in the movable holder parking area 20 according to the cargo collection attribute, and sending a transporting command to the handling equipment 40 so that the handling equipment 40 transports the bound holder from a starting position in the movable holder parking area 20 to the target position.

In some embodiments, the control device in the warehousing system 100 is configured to adjust the position of the bound holder in the movable holder parking area 20 so that a holder similarity similar has a maximum value. The holder similarity similar is calculated according to Formula (6):

$$similar = {\sum }_{x = 1}^{S - 1} {\sum }_{y = x + 1}^{S} {avgSimila}_{x y} \cdot \frac{1}{D i s {t}_{xy} + 1} ; \qquad ( 6 )$$

In formula (6), x is a positive integer and y is a positive integer. S is the number of all bound holders, and S is a positive integer. Distxy is a distance between the xth bound holder and the yth bound holder after the position adjustment, i.e. a distance between parking positions of the xth bound holder and the yth bound holder. avgSimila_{xy} is an average similarity of cargo collection attribute of the xth bound holder and the yth bound holder.

In some embodiments, the average similarity avgSimila_{xy} of cargo collection attributes can be calculated according to the following formula (7):

$$a v g S i m i l a {r}_{xy} = ( {\sum }_{i = 1}^{K x} {\sum }_{i = 1}^{K y} {Simi}_{ij} ) / ( Kx \times Ky ) ; \qquad ( 7 )$$

In formula (7), i is a positive integer and j is a positive integer. Kx is the number of bound containers of the xth bound holder, and Kx is a positive integer. Ky is the number of bound containers of the yth bound holder, and Ky is a positive integer.

For example, the Simiᵢⱼ value is calculated according to the following formula (8):

$${Simi}_{ij} = {\prod }_{m = 1}^{M} A {ttri}_{ijm} ; \qquad ( 8 )$$

In formula (8), m is a positive integer. M is the dimension of the specified cargo collection attribute, and M is a positive integer. When a value of the cargo collection attribute of the mth dimension of the ith bound container on the xth bound holder is the same as the value of the cargo collection attribute of the mth dimension of the jth bound container on the yth bound holder, a value of Attriᵢⱼₘ is 1; when the value of cargo collection attribute of the mth dimension of the ith bound container on the xth bound holder is different from the value of cargo collection attribute of the mth dimension of the jth bound container on the yth bound holder, the value of Attriᵢⱼₘ is 0.

The embodiments of the present disclosure provide a warehousing system 100 that after making the bound containers on each bound holder have the same value of cargo collection attribute, makes the bound containers having the same value of cargo collection attribute on it close to each other in space. That is, the warehousing system 100 aggregates the bound holders after tally on the placement position according to its cargo collection attribute, makes the bound holders having consistent cargo collection attribute close to each other, thus a plurality of regions in the movable holder parking area 20 is formed, and the bound holders in each region have relatively unified cargo collection attribute.

In some embodiments, the control device in the warehousing system 100 is configured to adjust the position of the bound holder in the movable holder parking area so that the holder movement value dcSCh has a minimum value. The holder movement value dcSCh is calculated according to the following formula (9):

$$dcSCh = {\sum }_{x = 1}^{S} {chaLo}_{x} ; \qquad ( 9 )$$

In formula (9), x is a positive integer. S is the number of all bound holders, and S is a positive integer. When the position of the xth bound holder is adjusted, a value of chaLo_{X} is 1; when the position of the xth bound holder is not adjusted, the value of chaLo_{X} is 0.

The following illustrates the process of adjusting the position of the bound holder in conjunction with the accompanying drawings.

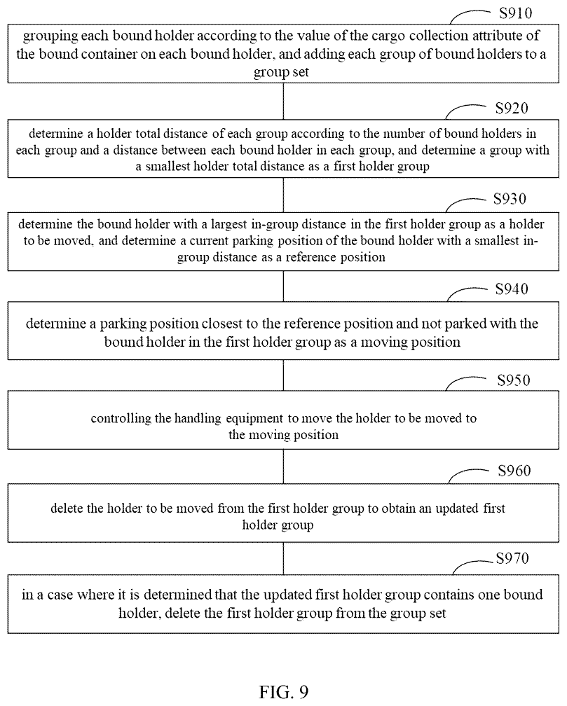

FIG. 9 is a schematic diagram of yet another scheduling method provided by some embodiments of the present disclosure. For example, the method can be performed by the control device in the warehousing system 100 in the above embodiment. As illustrated in FIG. 9, the method includes the steps illustrated below.

In step S910, according to the value of cargo collection attribute of the bound container on each bound holder, each bound holder is grouped, and each group of bound holders is added to a group set.

In some examples, the bound holders with the bound containers having the same value of each cargo collection attribute is added to a same group according to the value of cargo collection attribute of the bound container on each bound holder.

For example, in two bound holders, one has 11 bound containers on it, and the other has 12 bound containers on it. If all bound containers (for example, 23 bound containers) on the two bound holders have the same value of cargo collection attribute in each dimension, the two bound holders may be added to the same group.

Once all bound holders have been grouped, each group is added to the group set, which includes at least two groups.

In step S920, a holder total distance of each group is determined according to the number of bound holders in each group and the distance between each bound holder in each group, and the group with a smallest holder total distance is determined as a first holder group.

In some examples, the holder total distance tdis for each group is calculated according to the following formula (10):

$$tdis = ( {\sum }_{i = 1}^{N - 1} {\sum }_{j = i + 1}^{N} {D}_{ij} ) / [ N ( N - 1 ) / 2 ] ; \qquad ( 10 )$$

In formula (10), i is a positive integer and j is a positive integer. N is the number of bound holders in each group, and N is a positive integer. Dᵢⱼ is a distance between the ith bound holder and the jth bound holder in each group (i.e., a distance between parking positions of the ith bound holder and the jth bound holder).

The holder total distance for each group can be determined according to formula (10), and the group with the smallest holder total distance is determined as the first holder group.

In step S930, a bound holder with a largest in-group distance in the first holder group is determined as a holder to be moved, and a current parking position of a bound holder with a smallest in-group distance as a reference position.

For example, the in-group distance is a sum of distances between one bound holder and the remaining bound holders in the first holder group.

For example, the holder to be moved is a bound holder that needs to perform position adjustment, and the reference position is a parking position near a target position to which the moving holder needs to be moved.

In step S940, a parking position closest to the reference position and is not parked with the bound holder in the first holder group is determined as a moving position.

The moving position is a target position of the holder to be moved needing to be moved to. The move position is closest to the reference position and the move position is not parked with the bound holder in the first holder group.

In some embodiments, when there are a plurality of parking positions closest to the reference position, the value of cargo collection attribute of the bound container on fourth bound holders parked at the plurality of parking positions and the value of cargo collection attribute of the bound container on a fifth bound holder around the holder to be moved are determined; and a parking position of the fourth bound holder in the plurality of fourth bound holders having a value the same as the value of cargo collection attribute of the bound container on the fifth bound holder is determined as the moving position.

In some examples, the fourth bound holder is a bound holder in a second holder group, and the second holder group is different from the first holder group.

In step S950, the handling equipment is controlled to move the holder to be moved to the moving position.

For example, the control device can send a transporting instruction to the handling equipment 40 to control the handling equipment 40 to move the holder to be moved to the moving position.

In some embodiments, if the moving position is not parked with the movable holder, the holder to be moved is moved to the moving position; and if there is a movable holder parked in the moving position, the position of the holder to be moved is exchanged with the movable holder parked in the moving position.

In step S960, the holder to be moved is deleted from the first holder group to obtain an updated first holder group.

After the holder to be moved is moved to the moving position, the holder to be moved can be removed from the first holder group and update the first holder group.

In step S970, in a case where it is determined that the updated first holder group contains one bound holder, the first holder group is deleted from the group set.

In some examples, if the updated first holder group also includes at least two bound holders, above step S820 can be continued to perform to adjust the position of another bound holder in the first holder group.

Through the above process, the embodiments of the present disclosure take a bound holder in the bound holder group closest to the remaining bound holders as a center, starting from a bound holder in the group farthest away from the remaining bound holders, and transport each bound holder in the group to the center one by one, so that the bound holders in each group are aggregated in the placement position.

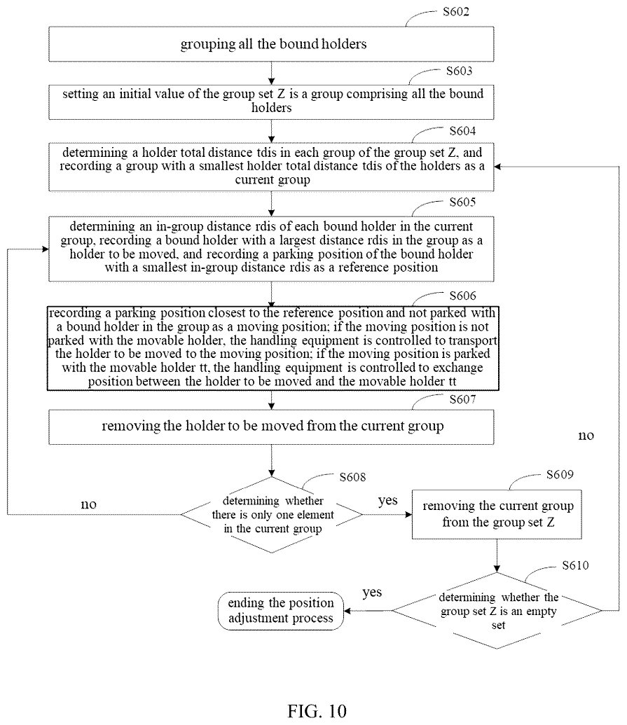

FIG. 10 is a schematic diagram of yet another scheduling method provided by some embodiments of the present disclosure. As illustrated in FIG. 10, after tallying, the control device in the warehousing system 100 is configured to perform the following position adjustment process to adjust the position of the bound holder according to the greedy algorithm.

In step S602, all bound holders are grouped, and then step S603 is performed.

The value of cargo collection attribute of M specified dimensions of the bound containers of the bound holders in the same group is the same.

For example, it is assumed that there are two bound holders A and B in a group, the bound holder A has 11 bound containers and the bound holder B has 12 bound containers. In the same group, the values of cargo collection attributes of M specified dimensions of the bound containers of the bound holders in the same group is the same, which means that the values of cargo collection attributes of M specified dimensions of all 23 bound containers in the two bound holders A and B are the same.

In step S603, the initial value of the group set Z is set to be a group including all bound holders, and then step S604 is performed.

In step S604, a holder total distance tdis in each group of the group set Z is determined, a group with a smallest holder total distance tdis is recorded as a current group, and then step S605 is performed.

The holder total distance tdis is calculated according to the following formula (10):

$$tdis = ( {\sum }_{i = 1}^{N - 1} {\sum }_{j = i + 1}^{N} {D}_{ij} ) / [ N ( N - 1 ) / 2 ] ; \qquad ( 10 )$$

In formula (10), i is a positive integer and j is a positive integer. N is the number of bound holders in each group, and N is a positive integer. Dᵢⱼ is a distance between the ith bound holder and the jth bound holder in each group (i.e., a distance between parking positions of the ith bound holder and the jth bound holder).

In step S605, the in-group distance rdis for each bound holder in the current group is determined, a bound holder with a largest in-group distance in the group is recorded as a holder to be moved, and a current parking position of a bound holder with a smallest in-group distance rdis in the group as a reference position, and then step S606 is performed.

The in-group distance rdis is a sum of distances between one bound holder in the group and the remaining bound holders in the group.

In step S606, a parking position closest to the reference position and is not parked with the bound holder in the group is recorded as a moving position, if the moving position is not parked with the movable holder, the handling equipment is controlled to transport the holder to be moved to the moving position, and if the moving position is parked with the movable holder tt, the handling equipment is controlled to exchange position between the holder to be moved and the movable holder TT, and then step S607 is performed.

In some examples, the holder to be moved is not moved if the distance between the moving position and the reference position is greater than or equal to the distance between the parking position of the holder to be moved and the reference position.

In step S607, the holder to be moved is removed from the current group, and then step S608 is performed.

In step S608, it is determined whether there is only one bound holder in the current group.

If there is only one bound holder in the current group, step S609 is performed, and if there are plurality of bound holders in the current group, step S605 is performed.

In steps S602 to S607, the warehousing system 100 aggregates the bound holders in each group in a placement position. Since the main cargo collection attribute value of bound holders in the same group is the same, it is possible to gather bound holders with relatively uniform cargo collection attribute to each other in the placement position. That is, a bound holder in the group closest to the remaining bound holders is taken as a center, and starting from a bound holder in the group farthest away from the remaining bound holders, each bound holder in the group is transported to the center one by one.

In step S609, the current group is removed from the group set Z, and then step S610 is performed.

In step S610, it is determined whether the group set Z is an empty set.

If the group set Z is an empty set, the position adjustment process is ended, and if the group set Z is not an empty set, step S604 is continued to perform.

The control device in the warehousing system 100 performs the gathering process of the above-mentioned bound holders one group by one group, and the bound holders of each group are relatively concentrated in its respective placement region.

In some embodiments, the control device in the warehousing system 100 is configured to, when there are a plurality of parking positions parked with bound holders tr not in the group closest to the reference position, a parking position of a bound holder of them with the value of cargo collection attribute of M specified dimensions the same as the value of cargo collection attribute of M specified dimensions of the bound holder ts around the holder to be moved is taken as the moving position.

In some embodiments, the movable holder 10 is arranged in rows and columns in the movable holder parking area 20, and the row number and column number of the bound holder ts around the holder to be moved and the row number and column number of the parking position of the holder to be moved may satisfy at least one of the following relationships: row numbers of the parking positions of the holder to be moved and the bound holder ts are identical, and column numbers differ by 1; column numbers of the parking positions of the holder to be moved and the bound holder ts are identical, and row numbers differ by 1; and row numbers and column numbers of the parking positions of the holder to be moved and the bound holder ts all differ by 1.

For example, as illustrated in FIG. 1, if the holder to be moved is a movable holder TOE, the bound holder ts around it may include movable holders 10A, 10B, 10C, 10D, 10F, 10H, 10I and 10J; if the holder to be moved is the movable holder 10I, the bound holder ts around it includes movable holders 10D, TOE, 10F, 10H and 10J; and if the holder to be moved is the movable holder 10J, the bound holder ts around it includes the movable holders TOE, 10I, and 10F.

In the embodiments of the present disclosure provide the warehousing system 100, when the bound holders of a group are gathered together with each other, the bound holders of other groups are also purposefully gathered with each other. For example, the control device in the warehousing system 100 may repeatedly perform steps S601 through step S610 several times. Each time it is performed, the aggregation of the bound holders (the consistency of cargo collection attribute) is optimized until the optimization effect reaches the desired goal or there is no room for further optimization.

In some embodiments, the workstation 60 and the hub station 30 both have the function of exchanging container 50 between the movable holders 10.

In some embodiments, during production time (e.g., during the day), the workstation 60 is used to perform the picking of cargo according to the order; during non-productive time (e.g., during the night), the handling equipment 40 transports the bound holder to at least one workstation 60. At least two bound holders are transported to the same workstation 60. The workstation 60 exchanges the container 50 on at least one first bound holder with the bound container on at least one additional second bound container according to the cargo collection attribute of the order of the bound container, so that the consistency of cargo collection attribute of the bound container on at least the first bound holder after the exchange is improved.

In some examples, a production task is to pick all of the items listed in an SKU of a current order from warehouse cargo, and to centrally pick all the items listed in the SKU of each current order into a same container or a plurality of containers. The production time refers to the time when the workstation 60 performs the production task. The time when the workstation 60 does not perform the production task is the non-productive time. That is, the workstation 60 is used for production during the working time and for automatic tally (container exchange between the first bound holder and the second bound holder is implemented) during the non-working time. For example, the above embodiment can perform tally only by the workstation 60.

In some embodiments, the workstation 60 includes a first temporary storage position and a first container pick-and-place device. The first temporary storage position is used to place a container, and the container is used to store cargo; the first container pick-and-place device is configured to: receive a tally instruction; in response to the tally instruction, exchange the container on at least one first bound holder with the bound container on at least one additional second bound holder through the first temporary storage position, so that the consistency of cargo collection attribute of the bound container on the first bound holder after the exchange is higher than the consistency of cargo collection attribute of the bound container on the first bound holder before the exchange.

In some examples, the first container pick-and-place device can remove the container on the first bound holder and place it on the first temporary storage position, remove the bound container on the second bound holder and place it on the first temporary storage position, and exchange the two containers.

In some embodiments, after the first bound holder and the second bound holder both arrive at the same workstation 60, the container exchange is performed. Alternatively, the first bound holder and the second bound holder are not located at the same workstation 60 simultaneously, and the workstation 60 uses the first temporary storage position to perform container exchange of the first bound holder and the second bound holder.

In some examples, the first container pick-and-place device may temporarily store the container of the first bound holder (or the second bound holder) that reaches the workstation 60 first on the first temporary storage position, and when the second bound holder (or the first bound holder) reaches the workstation, the container on the second bound holder (or the first bound holder) is placed on the first temporary storage position, the container of the first bound holder placed on the first temporary storage position is placed on the second bound holder, and the container of the second bound holder placed on the first temporary storage position is placed on the first bound holder to complete the container exchange.

For example, the warehousing system 100 can also complete tally through only the hub station 30, or, can also use the hub station 30 and the workstation 60 at the same time to complete tally. The embodiments of the present disclosure are not limited to this.

In some embodiments, the handling equipment 40 in the warehousing system 100 is configured to transport the bound holder to at least one hub station 30. At least two bound holders are transported to a same hub station 30. The hub station 30 is configured to exchange the container on at least one first bound holder with the bound container on at least one additional second bound holder according to the cargo collection attribute of the order of the bound container, so that the consistency of cargo collection attribute of the bound container on the first bound holder after the exchange is higher than the consistency of cargo collection attribute of the bound container on the first bound holders before the exchange.

In some embodiments, the hub station 30 includes at least one second guiding mechanism and a second container pick-and-place device arranged to the second guiding mechanism, and the second container pick-and-place device can be moved by the second guiding mechanism. The second container pick-and-place device is configured to: receive an tally instruction; in response to the tally instruction, exchange the container on at least one first bound holder with the bound container on at least one additional second bound holder, so that the consistency of cargo collection attribute of the bound container on the first bound holder after the exchange is higher than the consistency of cargo collection attribute of the bound container on the first bound holder before the exchange.

In some embodiments, the hub station 30 further includes a second temporary storage position configured to place the container. The second container pick-and-place device is configured to exchange the container on at least one first bound holder with the bound container on at least one additional second bound holder through the second temporary storage position in response to a tally instruction.

It should be noted that the function of the second temporary storage position is similar to that of the first temporary storage position in the workstation 60 in the above embodiment, and in order to avoid repetition, it is not described here.

In some embodiments, the control device in the warehousing system 100 may first determine at least two bound holders to be transported to the same station 60 (or hub station 30) and then determine to which workstation 60 (or hub station 30) they are transported. When a plurality of workstations 60 (and/or hub stations 30) are idle, the control device may separately calculate a length sum of movement paths of at least two bound holders to be transported from the movable holder parking area 20 to each of the plurality of idle workstations 60 (and/or hub stations 30) and take the workstation 60 (and/or hub station 30) having a smallest length sum of the movement paths as the same station 60 (and/or hub station 30).

The warehousing system 100 provided by the embodiments of the present disclosure can automatically place the bound containers (such as order boxes) with the same value of cargo collection attribute concentratedly on the same or several movable holders (such as racks) as much as possible, so that the warehouse position of the bound container is distributed regularly, not messy, saves transporting time, improves the efficiency of tally, and facilitates the development of logistics production work.

Some embodiments of the present disclosure provide a workstation, for example, the workstation is as the workstation 60 in the above embodiment (as illustrated in FIG. 2), and the workstation includes: a first temporary storage position and a first container pick-and-place device.

The first temporary storage position is used to place the container, and the container is used to store the cargo. The first container pick-and-place device is configured to: receive a tally instruction; in response to the tally instruction, exchange the container on at least one first bound holder with the bound container on at least one additional second bound holder through the first temporary storage position, so that the consistency of cargo collection attribute of the bound container on the first bound holder after the exchange is higher than the consistency of the bound container on the first bound holder before the exchange.

In some embodiments, the workstation further includes at least one first guiding mechanism. The first container pick-and-place device is arranged to the first guiding mechanism, and the first container pick-and-place device can move laterally and vertically through the first guiding mechanism.

In some embodiments, the workstation further includes: a first support frame. The first guiding mechanism includes a first lateral moving device, a first moving rod and a first vertical moving device. The first lateral moving device is arranged to the first support frame, and the lateral moving device can move laterally relative to the first support frame. The first moving rod extends along the vertical direction, and the first moving rod is arranged to the first lateral moving device, so that the first moving rod can move laterally relative to the first support frame. The first vertical moving device is arranged to the first moving rod, and the first vertical moving device can move vertically relative to the first moving rod. The first container pick-and-place device is arranged to the first vertical moving device.

Some embodiments of the present disclosure provide a hub station, the hub station is a hub station 30 as described in the above embodiment (as illustrated in FIG. 3), and the hub station includes at least one second guiding mechanism and a second container pick-and-place device arranged to the second guiding mechanism.

The second container pick-and-place device can be moved by the second guiding mechanism, and the second container pick-and-place device is configured to: receive a tally instruction; in response to the tally instruction, exchange the container on at least one first bound holder with the bound container on at least one additional second bound holder, so that the consistency of cargo collection attribute of the bound container on the first bound holder after the exchange is higher than the consistency of cargo collection attribute of the bound container on the first bound holder before the exchange.

In some embodiments, the hub station further includes: a second temporary storage position configured to place the container. The second container pick-and-place device is configured to exchange the container on at least one first bound holder with the bound container on at least one additional second bound holder through the second temporary storage position in response to the tally instruction.

In some embodiments, the hub station further includes: a second support frame. The second guiding mechanism includes a second lateral moving device, a second moving rod and a second vertical moving device. The second lateral moving device is arranged to the second support frame, and the second lateral moving device can move laterally relative to the second support frame; the second moving rod extends along the vertical direction, and the second moving rod is arranged to the second lateral moving device to move laterally synchronously with the second lateral moving device relative to the second support frame; the second vertical moving device is arranged to the second moving rod, and the second vertical moving device can move vertically relative to the second moving rod. The second container pick-and-place device is connected to the second vertical moving device.

The processes and steps described in the above embodiments are only examples. Unless an adverse effect occurs, various processing operations can be performed in an order different from the order of the above process. The sequence of steps in the above process can also be added, merged or deleted according to actual needs.

Unless otherwise defined, the technical and scientific terms used herein have the same meanings as generally understood by those skilled in the technical art of the present disclosure. The terms used herein are intended only to describe specific implementation purposes and are not intended to limit the present disclosure. The features described in one embodiment herein may be applied to another embodiment, either alone or in combination with other features, unless the feature is not applicable in that other embodiment or is otherwise indicated.

The present disclosure has been described by means of the above-mentioned embodiments, but it should be understood that the above-mentioned embodiments are only for the purpose of examples and illustration and are not intended to limit the present disclosure to the described embodiments. In addition, those skilled in the art can understand that the present disclosure is not limited to the above-mentioned embodiments, and more variants and modifications can be made according to the teachings of the present disclosure, and these variants and modifications fall within the scope of protection of the present disclosure.

1. A warehousing system, comprising:
a plurality of movable holders, each movable holder comprising a plurality of placement positions, and each placement position being used to place a container for storing cargo;
a movable holder parking area comprising a plurality of parking positions, each parking position being used to park one movable holder;
a control device configured to obtain an order and determines a bound container and a bound holder according to the order; wherein the bound holder is a movable holder carrying the bound container;
handling equipment coupled to the control device and configured to transport all the bound holders parked in the movable holder parking area to at least one workstation in the warehousing system, wherein at least two bound holders are transported to a same workstation; and
the workstation coupled to the control device and configured to exchange a container on at least one first bound holder with the bound container on at least one additional second bound holder according to a cargo collection attribute of the bound container, so that a consistency of the cargo collection attribute of the bound container on the first bound holder after exchange is higher than a consistency of the cargo collection attribute of the bound container on the first bound holder before the exchange.

2. The warehousing system according to claim 1, wherein the workstation is configured to:
exchange the bound container on the at least one first bound holder with the bound container on the at least one additional second bound holder according to the cargo collection attribute of the bound container, so that the consistency of the cargo collection attribute of the bound containers on the first bound holder after the exchange is higher than the consistency of the cargo collection attribute of the bound containers on the first bound holder before the exchange; and the consistency of a cargo collection attribute of the bound container on the second bound holder after the exchange is higher than the consistency of a cargo collection attribute of the bound container on the second bound holder before the exchange.

3. The warehousing system according to claim 2, wherein the control device is configured to:
determine a bound holder set and the cargo collection attribute of at least one dimension; wherein the bound holder set comprises a plurality of bound holders;
determining the first bound holder from the bound holder set and a main cargo collection attribute value of corresponding to the first bound holder according to the cargo collection attribute of at least one dimension; and
adding the bound container on the first bound holder having a cargo collection attribute value different from the main cargo collection attribute value to a bound container set, and
the workstation is configured to replace a first container in the bound container set with a second container on the second bound holder having a same cargo collection attribute value as the main cargo collection attribute value; wherein the first container is any container in the bound container set, and the second bound holder is a holder in the bound holder set different from the first bound holder.

4. The warehousing system according to claim 3, wherein the control device is configured to:
determine an aggregation degree of the cargo collection attribute of each bound holder according to a number of bound holders in the bound holder set and values of cargo collection attributes of the bound containers on each bound holder;
determine the bound holder with a largest aggregation degree of cargo collection attributes in the bound holder set as the first bound holder; and
determine the value of the cargo collection attribute corresponding to the aggregation degree of the first bound holder as the main cargo collection attribute value.

5. (canceled)

6. The warehousing system according to claim 3, wherein the control device is configured to:
in a case where the bound holder set comprises a plurality of third bound holders, determine a coincidence degree of a cargo collection attribute of each third bound holder and the first container according to a number of the bound containers on each third bound holder, the value of the cargo collection attribute of each third bound holder and the value of the cargo collection attribute of the first container; wherein the third bound holder is different from the first bound holder; and
determine the third bound holder having a highest coincidence degree of the cargo collection attribute is determined as the second bound holder.

7. The warehousing system according to claim 3, wherein the control device is further configured to:
delete the first container from the bound container arranged to obtain an updated bound container set; and
in the case where the updated bound container set is determined to be empty, delete the first bound holder from the bound holder set.

8. The warehousing system according to claim 1, wherein the control device is configured to perform following container exchange processes:
in S500, specifying M dimensions of a cargo collection attribute, and then perform step S501;
in S501, setting an initial value of the bound holder set T to include all the bound holders, and then performing step S502;
in S502, calculating the aggregation degree TG of each bound holder in the bound holder set T, and recording the bound holder with the largest aggregation degree TG of cargo collection attribute as a current bound holder thit; and then performing step S503,
wherein the aggregation degree of cargo collection attribute of a t^{th} bound holder in the bound holder set T is TGt; the aggregation degree of cargo collection attribute TGt is a maximum value of the same rate sart of cargo collection attribute of the t^{th} bound holder; the same rate sart of cargo collection attribute is the number of bound containers having the same values for all cargo collection attributes of the M dimensions in all K bound containers of the t^{th} bound holder divided by a value of the K;
in S503, recording the value of cargo collection attribute of the M dimensions corresponding to the aggregation degree TG of cargo collection attribute of the current bound holder thit as the main cargo collection attribute value; then performing step S504;
in S504, setting the initial value of the bound container set R to include the bound container having a value of cargo collection attribute of the M dimensions different from the main cargo collection attribute value in all the bound containers on the current bound holder thit; and then performing step S505;
in S505, selecting a bound container from the bound container set R, recording it as the current bound container chit; and then performing step S506;
in S506, selecting a bound holder to different from the current bound holder thit from the bound holder set T; wherein the bound holder to comprises the bound container cch having a value of cargo collection attribute of the M dimensions is the same as the main cargo collection attribute value; and then performing step S507;
in S507, controlling the workstation to replace the current bound container chit with the bound container cch on the bound holder to, and removing the current bound container chit from the bound container set R; and then performing step S508;
in S508, determining whether the bound container set R is an empty set, if so, performing step S509, if not, performing step S505;
in S509, removing the current bound holder thit from the bound holder set T; and then performing step S510; and
in S510, determining whether there is only one element in the bound holder set T, if so, ending the container exchange process, if not, performing the step S502.

9. (canceled)

10. The warehousing system according to claim 1, wherein the workstation is configured to:
exchange a container on the at least one first bound holder with the bound container on the at least one additional second bound holder, so that a total cargo collection similarity degree totalSimi after exchange has a maximum value; wherein the total cargo collection similarity degree totalSimi is calculated according to the following formula:
$$totalSimi = {\sum }_{i = 1}^{N - 1} {\sum }_{j = i + 1}^{N} [ {Simi}_{ij} \cdot \frac{{She}_{ij}}{{Dis}_{ij} + 1} - max ( 1 - {Simi}_{ij} , 0 ) \cdot {She}_{ij} \cdot P ] ;$$
wherein i is a positive integer, j is a positive integer, P is a constant, N is a number of all the bound containers, N is a positive integer, Simiᵢⱼ is a same rate of cargo collection attributes of an i^{th} bound container and an j^{th} bound container, and Disᵢⱼ is a distance between the bound holder where the i^{th} bound container is located and the bound holder where the j^{th} bound container is located after container exchange; and
after container exchange, when the i^{th} bound container and the j^{th} bound container are on the same bound holder, a value of the Sheᵢⱼ is 1; when the i^{th} bound container and the j^{th} bound container are not on the same bound holder, the value of Sheᵢⱼ is 0.

11. (canceled)

12. The warehousing system according to claim 1, wherein the workstation is configured to:
exchange the container on the at least one first bound holder with the bound container on the at least one additional second bound holder, so that a container movement value drSCh after the exchange has a minimum value; wherein the container movement value drSCh is calculated according to the following formula:
$$drSCh = {\sum }_{i = 1}^{N} {chaShe}_{i} ;$$
wherein i is a positive integer, N is a number of all bound containers, and N is a positive integer; when the movable holder used to place an i^{th} bound container is adjusted, a value of chaSheᵢ is 1; when the movable holder used to place the i^{th} bound container is not adjusted, the value chaSheᵢ is 0.

13. The warehousing system according to claim 1, wherein the control device is configured to:
select a container on the bound holder to bind the order, so that a coincidence degree avgSimi of cargo collection attributes of the order relative to the bound holder has a maximum value, wherein the coincidence degree avgSimi of cargo collection attributes is calculated according to the following formula:
$$avgSimi = \frac{{\sum }_{k = 1}^{K} ( 2 {\prod }_{m = 1}^{M} {Attri}_{k m} - 1 )}{K} ;$$
wherein k is a positive integer, m is a positive integer, K is a number of all the bound containers on the bound holder, K is a positive integer, M is a dimension of a specified cargo collection attribute, and M is a positive integer; when a value of cargo collection attribute of an m^{th} dimension of the order is the same as a value of a cargo collection attribute of the m^{th} dimension of a kth bound container on the bound holder, a value of Attriₖₘ is 1; when the value of cargo collection attribute of the m^{th} dimension of the order is different from the value of the cargo collection attribute of the m^{th} dimension of the k^{th} bound container on the bound holder, the value of Attriₖₘ is 0.

14. (canceled)

15. The warehousing system according to claim 1, wherein the control device is further configured to:
after the workstation exchanges the container on the at least one first bound holder with the bound container on the at least one additional second bound holder, adjusting a position of the bound holder in the movable holder parking area according to the cargo collection attribute.

16. The warehousing system according to claim 15, wherein the control device is configured to:
group each bound holder according to a value of the cargo collection attribute of the bound container on each bound holder, and add each group of bound holders to a group set;
determine a holder total distance of each group according to a number of bound holders in each group and a distance between each bound holder in each group, and determine a group with a smallest holder total distance as a first holder group;
determine the bound holder with a largest in-group distance in the first holder group as a holder to be moved, and determine a current parking position of the bound holder with a smallest in-group distance as a reference position; wherein an in-group distance is a sum of distances between a bound holder and remaining bound holders in the first holder group; and
determine a parking position closest to the reference position and not parked with the bound holder in the first holder group as a moving position, and
the handling equipment is configured to move the holder to be moved to the moving position.

17.-19. (canceled)

20. The warehousing system according to claim 16, wherein the control device is configured to perform the following position adjustment processes:
in S602, grouping all the bound holders, wherein the values of cargo collection attributes of the M dimensions of the bound containers of the bound holders in a same group are all the same; and then performing step S603;
in S603, setting an initial value of the group set Z is a group comprising all the bound holders; and then performing step S604;
in S604, determining a holder total distance tdis in each group of the group set Z, and recording a group with a smallest holder total distance tdis of the holders as a current group; and then performing step S605;
wherein the holder total distance tdis is calculated according to the following formula:
$$tdis = ( {\sum }_{i = 1}^{N - 1} {\sum }_{j = i + 1}^{N} {D}_{ij} ) / [ N ( N - 1 ) / 2 ] ;$$
wherein i is a positive integer, j is a positive integer, N is the number of bound holders in each group, and N is a positive integer, Dᵢⱼ is a distance between the i^{th} bound holder and the j^{th} bound holder in each group;
in S605, determining an in-group distance rdis of each bound holder in the current group, recording a bound holder with a largest distance rdis in the group as a holder to be moved, and recording a parking position of the bound holder with a smallest in-group distance rdis as a reference position; wherein the in-group distance rdis is a sum of distances of a bound holder in the group and remaining bound holders in the group; and then performing step S606;
in S606, recording a parking position closest to the reference position and not parked with a bound holder in the group as a moving position, wherein if the moving position is not parked with the movable holder, the handling equipment is controlled to transport the holder to be moved to the moving position; if the moving position is parked with the movable holder tt, the handling equipment is controlled to exchange position between the holder to be moved and the movable holder tt; if a distance between the moving position and the reference position is greater than or equal to a distance between the parking position of the holder to be moved and the reference position, the holder to be moved is not moved; and then performing step S607;
in S607, removing the holder to be moved from the current group; and then performing step S608;
in S608, determining whether there is only one bound holder in the current group, if so, performing the step S609, if not, performing the step S605;
in S609, removing the current group from the group set Z, and then performing step S610; and
in S610, determining whether the group set Z is an empty set, if so, ending the position adjustment process, if not, performing the step S604.

21.-22. (canceled)

23. The warehousing system according to claim 15, wherein the control device is configured to:
adjust a position of the bound holder in the movable holder parking area so that a holder similarity similar has a maximum value; wherein the holder similarity similar is calculated according to the following formula:
$$similar = {\sum }_{x = 1}^{S - 1} {\sum }_{y = x + 1}^{S} {avgSimila}_{xy} \cdot \frac{1}{D i s {t}_{xy} + 1} ;$$
wherein x is a positive integer, y is a positive integer, S is a number of all the bound holders, S is a positive integer, avgSimila_{xy} is an average similarity of cargo collection attributes of an x^{th} bound holder and a y^{th} bound holder, and Dist_{xy} is a distance between the x^{th} bound holder and the y^{th} bound holder after an adjustment of the position of the x^{th} bound holder.

24. (canceled)

25. The warehousing system according to claim 15, wherein the control device is configured to:
adjust a position of the bound holder in the movable holder parking area so that a holder movement value dcSCh has a minimum value, wherein the holder movement value dcSCh is calculated according to the following formula:
$$dcSCh = {\sum }_{x = 1}^{S} {chaLo}_{x} ;$$
wherein when the position of an x^{th} bound holder is adjusted, a value of chaLoₓ is 1; when the position of the x^{th} bound holder is not adjusted, the value of chaLoₓ is 0.

26. The warehousing system according to claim 1, wherein the control device is configured to:
determine at least two bound holders to be transported from the movable holder parking area to a same workstation;
when there are a plurality of idle workstations, calculating a length sum of moving paths between the at least two bound holders and each idle workstation in the plurality of idle workstations; and
transporting the at least two bound holders from the movable holder parking area to an idle workstation with a smallest length sum of moving paths in the plurality of idle workstations.

27. The warehousing system according to claim 1, wherein the workstation comprises:
a first temporary storage position used to place the container; and
a first container pick-and-place device coupled to the control device and is used to move the container between the placement position and the first temporary storage position.

28.-29. (canceled)

30. The warehousing system according to claim 1, wherein the warehousing system further comprises at least one hub station, and the at least one hub station is used to perform the container exchange between at least two movable holders; and the handling equipment is configured to:
transport the bound holder to the at least one hub station, wherein the at least two bound holders are transported to the same hub station;
the at least one hub station is configured to exchange the container on the at least one first bound holder with the bound container on the at least one additional second bound holder according to the cargo collection attribute of the bound container, so that the consistency of the cargo collection attribute of the bound container on the first bound holder after exchange is higher than the consistency of the cargo collection attribute of the bound container on the first bound holder before the exchange.

31. (canceled)

32. A scheduling method, comprising:
determining a bound container and a bound holder according to an order, wherein the bound holder is a movable holder carrying the bound container;
sending a transporting instruction to a handling equipment so that the handling equipment transports all the bound holders to at least one workstation, wherein at least two bound holders are moved to a same workstation;
sending a tally instruction to the workstation so that the workstation exchanges a container on at least one first bound holder with the bound container on at least one additional second bound holder according to a cargo collection attribute of the bound container, and a consistency of the cargo collection attribute of the bound container on the first bound holder after exchange is higher than a consistency of the cargo collection attribute of the bound container on the first bound holder before the exchange.

33.-36. (canceled)

37. A workstation comprising:
a first temporary storage position used to place a container, and the container being used to store cargo; and
a first container pick-and-place device configured to: receive a tally instruction; in response to the tally instruction, exchange a container on at least one first bound holder with the bound container on at least one additional second bound holder through the first temporary storage position, so that a consistency of a cargo collection attribute of the bound container on the first bound holders after exchange is higher than a consistency of the cargo collection attribute of the bound container on the first bound holder before the exchange.

38. (canceled)
